(19) United States
(12) Patent Application Publication
(10) Pub. No.: US 2019/0357071 A1
(43) Pub. Date: Nov. 21, 2019

(54) USER DEVICE AND RADIO COMMUNICATION METHOD

(71) Applicant: NTT DOCOMO, INC., Tokyo (JP)

(72) Inventors: Wuri Andarmawanti Hapsari, Tokyo (JP); Hideaki Takahashi, Tokyo (JP); Tooru Uchino, Tokyo (JP); Kohei Kiyoshima, Tokyo (JP)

(73) Assignee: NTT DOCOMO, INC., Tokyo (JP)

(21) Appl. No.: 16/482,876

(22) PCT Filed: Feb. 1, 2018
(86) PCT No.: PCT/JP2018/003430

§ 371 Date: Aug. 1, 2019

(30) Foreign Application Priority Data
Feb. 2, 2017 (JP) 2017-017970

(51) Int. Cl. H04W 24/10; H04W 72/08; H04W 76/10; H04W 76/27; H04W 76/28

(52) U.S. Cl. CPC H04W 24/10; H04W 72/085; H04W 76/28; H04W 76/27; H04W 76/10

(57) ABSTRACT

User device and a radio communication method are provided which are capable of achieving further battery saving even in a state where connection on an RRC layer is established. UE 200 sends a radio access network a measurement report which contains a reception quality of at least one of a serving cell and a neighboring cell. The UE 200 sets the UE 200 to a DRX state in an RRC_Connected state where connection on a radio resource control layer is established. When the UE 200 is set to the DRX state, the UE 200 cancels processing P1 including the transmission of the measurement report.

### TECHNICAL FIELD

The present invention relates to user device and a radio communication method, which are designed to send a radio access network a measurement report including reception qualities of a serving cell and of a neighboring cell.

### BACKGROUND ART

3rd Generation Partnership Project (3GPP) specifies Long Term Evolution (LTE), and with the aim of further speeding, specifies the LTE including LTE-Advanced (hereinbelow, the LTE includes the LTE-Advanced).

The LTE defines a discontinuous reception (DRX) state (a discontinuous reception state) to allow user device (User Equipment, UE) to intermittently receive signals (channels) transmitted from a radio access network for battery saving (see Non-patent document 1, for example).

Specifically, when a prescribed condition (such as expiration of a DRX inactivity timer) is satisfied in a state (an RRC_Connected state) where connection on a radio resource control layer (an RRC layer) is established, the UE can transition from a non-DRX state to the DRX state. The UE in the DRX state attempts reception of a PDCCH (physical downlink control channel) periodically (which is called on-duration).

### PRIOR ART DOCUMENT

### Non-Patent Document

Non-patent document 1: 3GPP TS 36.300 V14.1.0 Subclause 12 DRX in RRC_CONNECTED, 3rd Generation Partnership Project; Technical Specification Group Radio Access Network; Evolved Universal Terrestrial Radio Access (E-UTRA) and Evolved Universal Terrestrial Radio Access Network (E-UTRAN); Overall description; Stage 2 (Release 14), 3GPP, December 2016.

### SUMMARY OF THE INVENTION

As described above, the UE in the RRC_Connected state can transition to the DRX state. Here, because of being in the RRC_Connected state, the UE sends the radio access network a measurement report containing reception qualities of a serving cell and of a neighboring cell.

However, there is room for improvement in the aforementioned operation from the battery-saving viewpoint for the UE. Further battery saving is expected particularly for the UE mounted on a small unmanned air vehicle such as a drone, due to its likelihood of frequent transmission of the measurement reports and a difficulty to secure a power source during its flight.

The present invention has been made in view of the above-mentioned circumstances. An objective of the present invention is to provide user device and a radio communication method, which are capable of achieving further battery saving even in a state where communication is established on an RRC layer.

User device according to an aspect of the present invention transmits a message on a radio resource control layer to a radio access network. The user device includes a reception state control unit that sets the user device to a discontinuous reception state in a connected state where connection on the radio resource control layer is established. The reception state control unit cancels transmission of the message when the user device is set to the discontinuous reception state.

Preferably, the user device further includes a measurement report unit that transmits a measurement report to the radio access network, the measurement report containing a reception quality of at least one of a serving cell and a neighboring cell, in which the measurement report unit cancels the transmission of the measurement report when the user device is set to the discontinuous reception state by the reception state control unit.

A radio communication method according to another aspect of the present invention includes transmitting a message on a radio resource control layer to a radio access network, setting user device to a discontinuous reception state in a connected state where connection on the radio resource control layer is established, and cancelling transmission of the message when the user device is set to the discontinuous reception state.

Preferably, the radio communication method further includes transmitting a measurement report to the radio access network, the measurement report containing a reception quality of at least one of a serving cell and a neighboring cell, and cancelling the transmission of the measurement report when the user device in the connected state is set to the discontinuous reception state.

### BRIEF DESCRIPTION OF THE DRAWINGS

FIG. 1 is an overall schematic configuration diagram of a radio communication system 10.

FIG. 2 is a functional block configuration diagram of UE 200.

FIG. 3 is a diagram showing a transmission sequence of a measurement report between an eNB 100 and the UE 200.

FIG. 4 is a diagram showing an operation to process the measurement report inside the UE 200.

FIG. 5 is an explanatory diagram of an operation to cancel transmission of the measurement report (Operation Example 1) in an RRC_Connected state and concurrently in a DRX state.

FIG. 6 is an explanatory diagram of an operation to cancel transmission of the measurement report (Operation Example 2) in an RRC_Connected state and concurrently in a DRX state.

FIG. 7 is an explanatory diagram of an operation to cancel transmission of the measurement report (Operation Example 3) in an RRC_Connected state and concurrently in a DRX state.

FIG. 8 is an explanatory diagram of an operation to cancel transmission of the measurement report (Modified Example 1) in an RRC_Connected state and concurrently in a DRX state.

FIG. 9 is an explanatory diagram of an operation to cancel transmission of the measurement report (Modified Example 2) in an RRC_Connected state and concurrently in a DRX state.

FIG. 10 is a diagram showing an example of a hardware configuration of the UE 200.

### MODE FOR CARRYING OUT THE INVENTION

An embodiment is described below with reference to the drawings. Note that identical functions and configurations are denoted by identical or similar reference numerals and explanations thereof are omitted as appropriate.

### (1) Overall Schematic Configuration of Radio Communication System

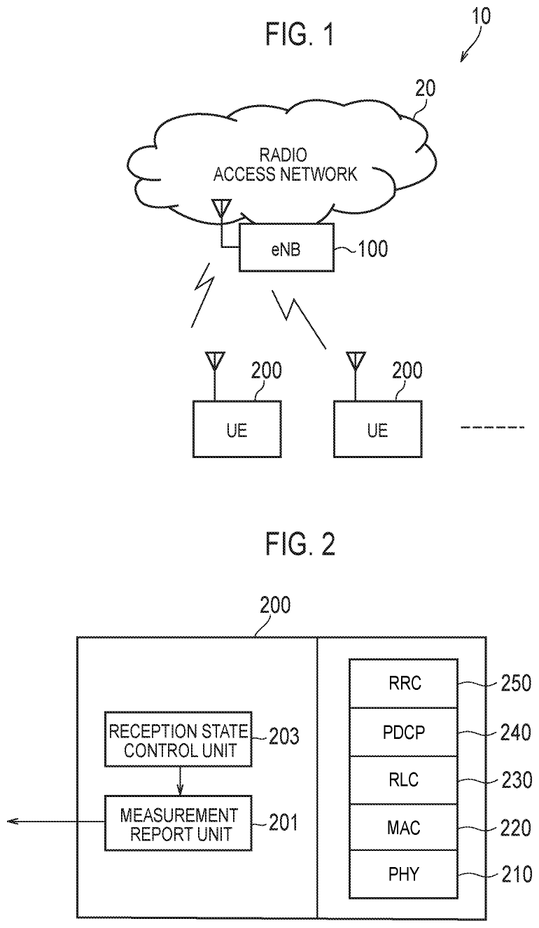

FIG. 1 is an overall schematic configuration diagram of a radio communication system 10 of this embodiment. The radio communication system 10 is a radio communication system which complies with the Long Term Evolution (LTE) specifications, and includes a radio access network 20 and a mobile station 200 (hereinafter UE 200).

The radio access network 20 is an evolved universal terrestrial radio access network (E-UTRAN) defined by the 3GPP, which includes a radio base station 100 (hereinafter an eNB 100). Note that the radio communication system 10 is not necessarily limited to the LTE (E-UTRAN). For example, the radio access network 20 may be a radio access network including a radio base station that executes radio communication with User Equipment, UE 200 (user device) defined as 5G, for example.

The eNB 100 and the UE 200 execute radio communication in compliance with the LTE specifications. Although only one eNB 100 is illustrated in FIG. 1, the radio access network 20 includes multiple sets of the eNB 100 and the multiple sets of the eNB 100 form multiple cells (not shown).

The UE 200 determines a serving cell (a cell in a state of connection on an RRC layer (an RRC_Connected state)) out of the multiple cells. Here, the serving cell that is also called a current cell may also be called a PCell or a PSCell (in the case of dual connectivity).

Meanwhile, the UE 200 can send the radio access network 20 a message (an RRC message) on the radio resource control layer.

Moreover, the UE 200 measures reception qualities (such as RSRP/RSRQ) of the serving cell and of a neighboring cell formed in the vicinity of the serving cell, and sends the radio access network 20 a measurement report that contains the reception qualities.

### (2) Functional Block Configuration of Radio Communication System

Next, a functional block configuration of the radio communication system 10 is described. Specifically, a description is given of a functional block configuration of the UE 200.

FIG. 2 is a functional block configuration diagram of the UE 200. As shown in FIG. 2, the UE 200 includes a measurement report unit 201 and a reception state control unit 203.

In addition, the UE 200 includes a protocol stack formed from multiple layers. Specifically, starting from a lower layer, the protocol stack includes a physical layer 210 (hereinafter a PHY layer 210), a medium access control layer 220 (hereinafter an MAC layer 220), a radio link control layer 230 (hereinafter an RLC layer 230), a packet data convergence protocol layer 240 (hereinafter a PDCP layer 240), and a radio resource control layer 250 (hereinafter an RRC layer 250) which are arranged in this order as shown in FIG. 2. Moreover, the protocol stack includes a non-access stratum (NAS) layer (not shown) as an upper layer of the RRC layer 250.

Functional blocks of the measurement report unit 201 and the reception state control unit 203 are realized by using one or more of the layers constituting the protocol stack. Meanwhile, although it is not illustrated, the UE 200 includes a battery to drive hardware that constitutes the UE 200. Note that a hardware configuration of the UE 200 is described later.

The measurement report unit 201 sends the radio access network 20 the measurement report which contains the reception quality of at least one of the serving cell and the neighboring cell.

Specifically, the measurement report unit 201 measures RSRP/RSRQ (reference signal received power/reference signal received quality) and the like of reference signals transmitted from the serving cell and the neighboring cell. When an entering condition of a prescribed event is satisfied, the measurement report unit 201 transmits the measurement report including a result of the measurement.

Examples of the entering condition include a condition where the reception quality exceeds a threshold, a condition where the reception quality of the neighboring cell exceeds the reception quality of the serving cell, and so forth.

The reception state control unit 203 controls a reception state of the UE 200. Specifically, the reception state control unit 203 controls the UE 200 either in a non-DRX state or in a DRX state.

The non-DRX state is a state where signals (channels) from the radio access network 20 are continuously received without executing battery saving. The non-DRX state may also be called an active state and the like.

The DRX state is a state where the channels transmitted from the radio access network 20 are received intermittently (i.e., periodically). The DRX state may also be called a non-active state and the like.

Specifically, in the DRX state, the UE 200 attempts reception of the PDCCH only for each period (on-duration, 6 ms) that comes up periodically, by using the above-mentioned protocol stack.

In the RRC_Connected state (a connected state) where the connection on the RRC layer 250 is established, the reception state control unit 203 sets the UE 200 to the DRX state (a discontinuous reception state). Here, the reception state control unit 203 can also set the UE 200 to the DRX state in an idle state where the connection is not established.

Meanwhile, the reception state control unit 203 can cancel the transmission of the RRC message (such as a UE information response) when the UE 200 is set to the DRX state.

Next, a description is given of an operation of the measurement report unit 201 when the reception state control unit 203 sets the UE 200 to the RRC_Connected state and to the DRX state concurrently.

The measurement report unit 201 cancels the transmission of the measurement report when the user device is set to the RRC_Connected state and to the DRX state concurrently.

Specifically, on the MAC layer 220, the measurement report unit 201 can cancel transmission of a corresponding signal corresponding to the measurement report. The corresponding signal is any one of a scheduling request (SR), a buffer status report (BSR) of a signaling radio bearer (SRB), and a RACH (random access channel).

To be more precise, the measurement report unit 201 cancels the transmission of the corresponding signal based on an indicator of the measurement report (MR indication) notified from the RRC layer 250.

Moreover, the measurement report unit 201 can cancel the transmission of the measurement report on the RRC layer 250.

Specifically, the measurement report unit 201 cancels the transmission of the measurement report based on an event that the MAC layer 220 notifies the RRC layer 250 of transition of the UE 200 to the DRX state.

Furthermore, the measurement report unit 201 can also notify the PHY layer 210 of cancellation of the transmission of the measurement report on the MAC layer 220.

### (3) Operations of Radio Communication System

Next, operations of the radio communication system 10 are described. Specifically, a description is given of a transmission operation of the measurement report and a cancellation operation of the transmission to be executed by the UE 200.

### (3.1) Transmission Sequence of Measurement Report

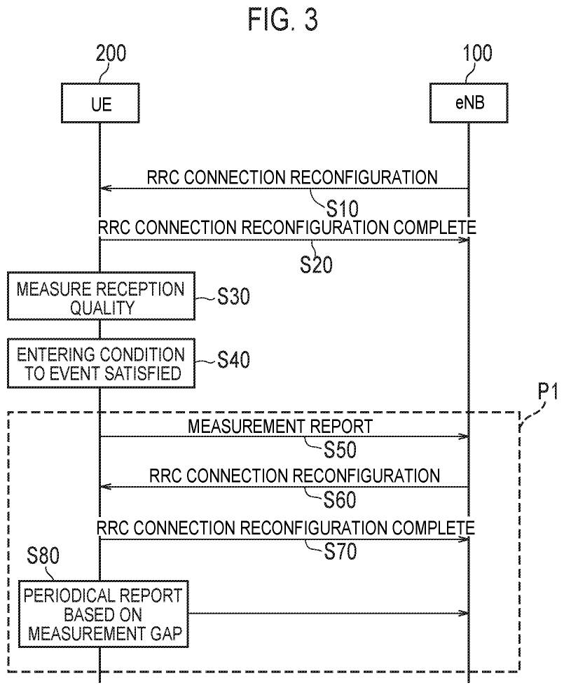

FIG. 3 shows a transmission sequence of the measurement report between the eNB 100 and the UE 200. As shown in FIG. 3, the eNB 100 transmits an RRC connection reconfiguration to the UE 200 (S10). Specifically, the eNB 100 notifies the UE 200 of setting information (MeasConfig) necessary for the transmission of the measurement report by the UE 200 in the RRC_Connected state.

In response to the received RRC Connection Reconfiguration, the UE 200 transmits an RRC Connection Reconfiguration Complete to the eNB 100 (S20). Meanwhile, the UE 200 repeatedly measures the reception qualities of the serving cell and the neighboring cell based on the notified setting information (S30).

When results of measurement of the reception qualities satisfy the entering condition of the prescribed event, the UE 200 transmits the measurement report to the eNB 100 (S40, S50). Specifically, the UE 200 sends the eNB 100 the result of measurement of the reception qualities and the content of the satisfied event. To be more precise, the results of measurement include a measurement identity (MeaslD), the reception quality of the serving cell, and the reception quality of the neighboring cell.

Though a typical example of such a reception quality is the RSRP/RSRQ (in the case of the LTE), the reception quality may be an RSCP, an RSSI, an Ec/No, and the like instead.

The eNB 100 transmits the RRC Connection Reconfiguration to the UE 200 in order to instruct setting changes and the like corresponding to the reception state (the satisfied event) of the UE 200 and so forth (S60).

The UE 200 changes the settings based on a content of the received RRC Connection Reconfiguration, and transmits the RRC Connection Reconfiguration Complete to the eNB 100 (S70).

Meanwhile, the UE 200 sets a measurement gap of the reception quality corresponding to the satisfied event, and executes determination of a necessity of a hangover and the like (S80). Note that the measurement gap represents a period for allowing the UE 200 to execute a measurement on a different frequency band or with a different radio access technology (RAT), which is a periodical session dedicated to the measurement without conducting transmission or reception of other data.

When the UE 200 is in the RRC_Connected state, the above-described transmission and reception of the RRC Connection Reconfiguration and the RRC Connection Reconfiguration Complete is executed and the measurement report is transmitted since the UE 200 is undeniably in the RRC_Connected state.

On the other hand, in this embodiment, processing P1 surrounded by a dashed line is not executed when the UE 200 is in the RRC_Connected state and concurrently in the DRX state.

### (3.2) Processing of Measurement Report Inside UE 200

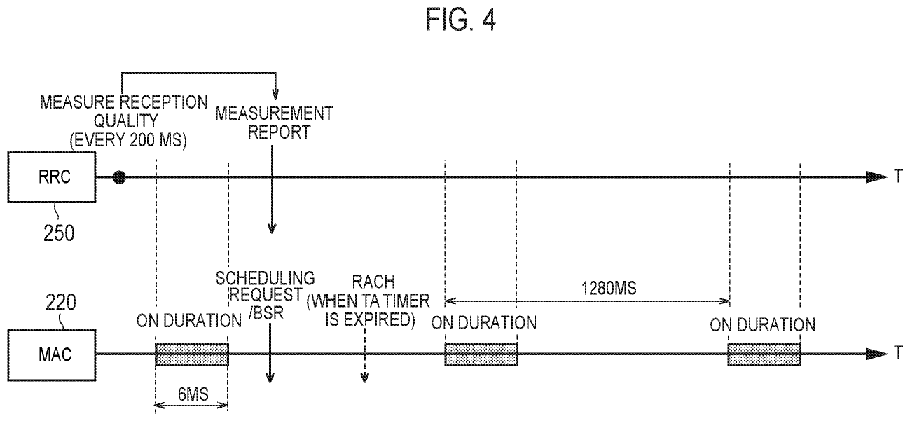

FIG. 4 shows an operation to process the measurement report inside the UE 200. Specifically, FIG. 4 illustrates an operation to transmit the measurement report when the UE 200 is in the RRC_Connected state and concurrently in the DRX state, i.e., in the case of not cancelling the transmission of the measurement report.

The UE 200 transitions to the DRX state when the UE 200 does not receive the PDCCH for a defined period of time (when the DRX inactivity timer is expired), or when the UE 200 is instructed to transition to the DRX state by a DRX command MAC control element.

As shown in FIG. 4, the RRC layer 250 of the UE 200 measures the reception quality of the cell periodically (sampling in each 200 ms), thereby generating the measurement report.

When the measurement report is triggered, the MAC layer 220 of the UE 200 transmits the scheduling request at a timing when resources for transmitting the most recent scheduling recent are available. In the meantime, when the measurement report is triggered, the MAC layer 220 triggers transmission of the buffer status report (BSR) in order to transmit data routed through the SRB (hereinafter SRB data).

Note that the above-described operation of the MAC layer 220 is executed when a timing advance (TA) timer (TA timer) is not expired. The TA timer is a timer which monitors synchronism on an uplink (UL). The operation of the TA timer is executed independently of a DRX operation.

When the TA timer is not expired, UL dedicated resources are regularly present. Accordingly, the UE 200 (the MAC layer 220) transmits the scheduling request by using the most recent resources as described above. By transmitting the scheduling request, the UE 200 establishes the active state (the non-DRX state) and can receive a UL grant from the radio access network 20. In this way, it is possible to report the measurement report to the radio access network 20.

On the other hand, when no TA command is received over a defined period of time (when the TA timer is expired), the UE 200 releases the UL dedicated resources (a CQI (channel quality indication), the SR, and an SRS (sounding reference signal)).

In this case, as shown in FIG. 4, the UE 200 (the MAC layer 220) executes random access (RA) procedures by using the most recent RACH resources after the measurement report is triggered. Specifically, the UE 200 establishes the active state (the non-DRX state) by receiving an Msg. 4 (an RRC connection setup) defined in the RA procedures. Thus, the UE 200 can receive the UL grant from the radio access network 20. This makes it possible to report the measurement report to the radio access network 20.

Meanwhile, in the DRX state, the UE 200 (the MAC layer 220) attempts reception of the PDCCH during each on-duration period (6 ms) that comes up periodically (every 1280 ms).

### (3.3) Cancellation Operation of Transmission of Measurement Report

The operation to transmit the measurement report in the RRC_Connected state and concurrently in the DRX state is described with reference to FIG. 4 mentioned above. Next, an operation to cancel the transmission of the measurement report in the RRC_Connected state and concurrently in the DRX state is described.

### (3.3.1) Operation Example 1

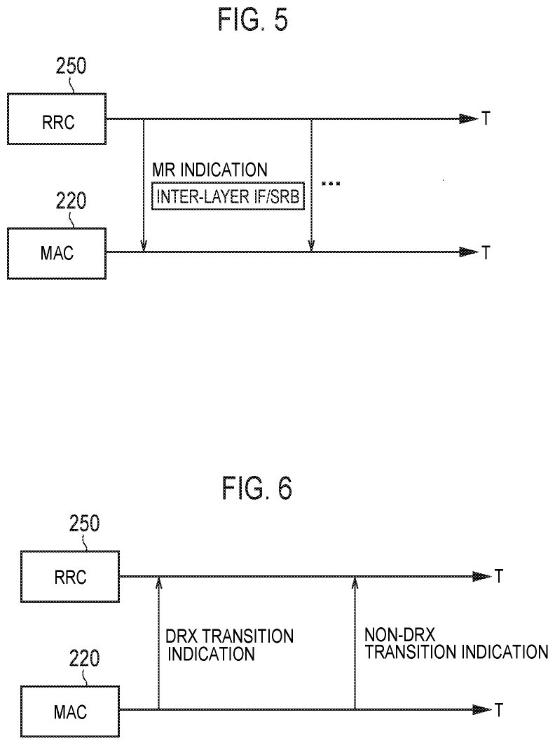

FIG. 5 is an explanatory diagram of an operation to cancel the transmission of the measurement report (Operation Example 1) in the RRC_Connected state and concurrently in the DRX state. In this operation example, the transmission of the measurement report (hereinafter MR) is cancelled on the MAC layer 220.

Specifically, the RRC layer 250 notifies the MAC layer 220 of the MR indication together with the content of the MR in order to cancel an operation concerning transmission of any of the scheduling request (SR), the BSR, and the RACH used for the transmission of the MR. As described above, the MR indication is the indicator of the MR, which indicates a request to the MAC layer 220 in association with the transmission of the MR, that is to say, a signal type of the RRC layer 250.

To be more precise, the RRC layer 250 notifies the MAC layer 220 of the MR indication through an interface (an inter-layer I/F) between the RRC layer 250 and the MAC layer 220. In this case, the MAC layer 220 discards the SRB data received at the closest timing to a reception timing of the MR indication.

Alternatively, the RRC layer 250 may add the MR indication (corresponding to a header) to the SRD data, and then transmit this data to the MAC layer 220. In this case, the MAC layer 220 discards the SRB data that contains the MR indication.

### (3.3.2) Operation Example 2

FIG. 6 is an explanatory diagram of another operation to cancel the transmission of the measurement report (Operation Example 2) in the RRC_Connected state and concurrently in the DRX state. In this operation example, the transmission of the MR is cancelled on the RRC layer 250. That is to say, in the RRC_Connected state and concurrently in the DRX state, the MR is not generated right from the beginning.

Specifically, when the UE 200 in the RRC_Connected state transitions to the DRX state, the MAC layer 220 notifies the RRC layer 250 of the transition to the DRX state.

Even when the entering condition of the prescribed event is satisfied, the RRC layer 250 ignores the event and does not generate the MR.

To be more precise, the MAC layer 220 notifies the RRC layer 250 of the transition to the DRX state (a DRX transition indication) through the interface (the inter-layer I/F) between the RRC layer 250 and the MAC layer 220. Meanwhile, when the UE 200 returns (transitions) to the non-DRX state, the MAC layer 220 notifies of the transition to the non-DRX state (a Non-DRX transition indication).

### (3.3.3) Operation Example 3

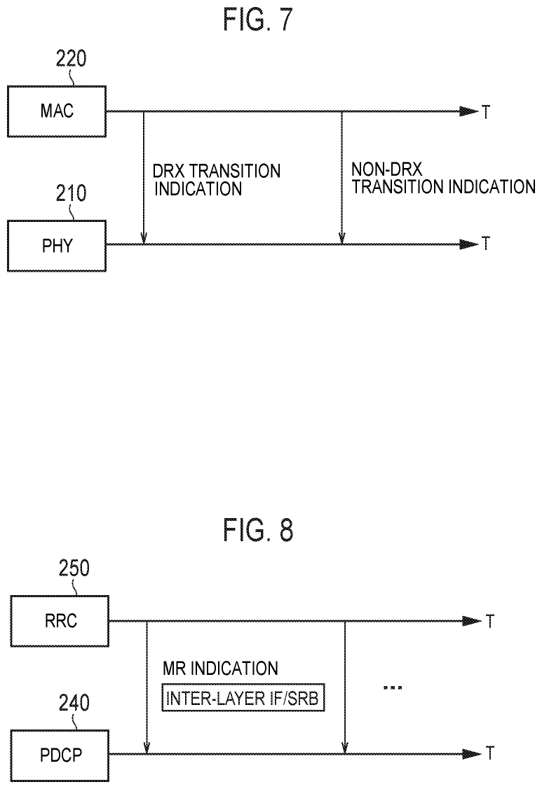

FIG. 7 is an explanatory diagram of another operation to cancel the transmission of the measurement report (Operation Example 3) in the RRC_Connected state and concurrently in the DRX state. In this operation example, the MAC layer 220 notifies the PHY layer 210 of the transition to the DRX state so as to cause the PHY layer 210 to recognize that the MR is not to be transmitted. That is to say, this operation example is defined as RAN4 requirement.

Specifically, when the UE 200 in the RRC_Connected state transitions to the DRX state, the MAC layer 220 notifies the PHY layer 210 of the transition to the DRX state.

To be more precise, the MAC layer 220 notifies of the transition to the DRX state (the DRX transition indication).

Meanwhile, when the UE 200 returns (transitions) to the non-DRX state, the MAC layer 220 notifies of the transition to the non-DRX state (the Non-DRX transition indication). This causes the PHY layer 210 to recognize that an RRM (radio resource management) measurement is not to be executed. Meanwhile, in the case of the return to the non-DRX state, the MAC layer 220 causes the PHY layer 210 to resume the RRM measurement.

### (3.3.4) Modified Example 1

In the above-described Operation Example 1, the RRC layer 250 uses the MR indication to notify the MAC layer 220 of the request associated with the transmission of the MR. However, the following change may take place when the MR indication is used.

FIG. 8 is an explanatory diagram of another operation to cancel the transmission of the measurement report (Modified Example 1) in the RRC_Connected state and concurrently in the DRX state. In this modified example, the transition of the MR is cancelled on the PDCP layer 240.

Specifically, the PDCP layer 240 discards the SRB data that contains the MR indication. To be more precise, the RRC layer 250 notifies the PDCP layer 240 of the MR indication through an interface (an inter-layer I/F) between the RRC layer 250 and the PDCP layer 240. In this case, the PDCP layer 240 discards the SRB data received at the closest timing to the reception timing of the MR indication.

Alternatively, the RRC layer 250 may add the MR indication (corresponding to the header) to the SRD data, and then transmit this data to the PDCP layer 240. In this case, the PDCP layer 240 discards the SRB data that contains the MR indication.

### (3.3.5) Modified Example 2

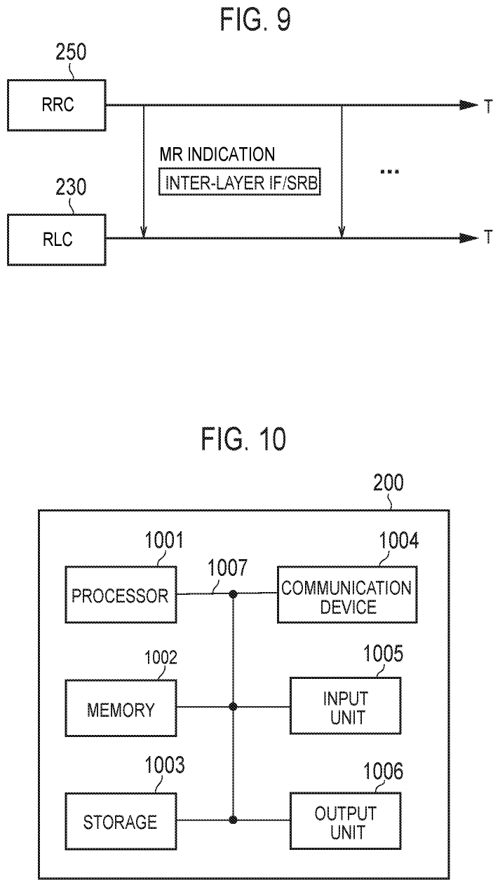

FIG. 9 is an explanatory diagram of another operation to cancel the transmission of the measurement report (Modified Example 2) in the RRC_Connected state and concurrently in the DRX state. In this modified example as well, the MR indication is used as with Modified Example 1. However, the transition of the MR is cancelled on the RLC layer 230.

Specifically, the RLC layer 230 discards the SRB data that contains the MR indication. To be more precise, the RRC layer 250 notifies the RLC layer 230 of the MR indication through an interface (an inter-layer I/F) between the RRC layer 250 and the RLC layer 230. In this case, the RLC layer 230 discards the SRB data received at the closest timing to the reception timing of the MR indication.

In the meantime, as with Modified Example 1, the RRC layer 250 may add the MR indication (corresponding to the header) to the SRD data, and then transmit this data to the RLC layer 230. In this case, the RLC layer 230 discards the SRB data that contains the MR indication.

### (4) Effects and Advantages

According to the above-described embodiment, when the UE 200 in the RRC_Connected state is set to the DRX state, the UE 200 cancels the transmission of the measurement report (MR). For this reason, in the case of the DRX state, the transmission of the MR is cancelled even in the RRC_Connected state. Thus, it is possible to suppress power consumption associated with the transmission of the MR.

In other words, according to the UE 200, it is possible to achieve further battery saving even in the RRC_Connected state. Moreover, the saving of the radio resources can also be expected since the transmission of the MR is cancelled in the RRC_Connected state and concurrently in the DRX state.

According to the existing framework for the measurement report in the LTE, the MR is transmitted in the RRC_Connected state regardless of being in the non-DRX state or in the DRX state. In contrast, according to this embodiment, the transmission of the MR is proactively cancelled in the DRX state from the battery-saving viewpoint. In this way, it is also possible to deal with such a case as the UE to be mounted on a small unmanned air vehicle like a drone, in particular, where it is highly likely that the measurement reports are transmitted frequently and it is not easy to secure a power source during its flight.

In this embodiment, the transmission of the MR can be cancelled by the cooperation of the RRC layer 250 with the MAC layer 220 (Operation Example 1) while using the indicator of the measurement report (the MR indication). Meanwhile, the transmission of the MR can also be cancelled by the cooperation of the RRC layer 250 with the PDCP layer 240 (Modified Example 1) or with the RLC layer 230 (Modified Example 2) while using the MR indication. As a consequence, it is possible to cause a layer lower than the RRC layer 250 to recognize the cancellation of the transmission of the MR demonstratively by using the MR indication.

In this embodiment, the RRC layer 250 can cancel (or resume) the transmission of the MR based on the notification of the transition to the DRX state (or the return to the non-DRX state) (the DRX transition indication or the Non-DRX transition indication) from the MAC layer 220. For this reason, the RRC layer 250 can surely cancel the transmission of the MR in the DRX state based on the notification.

In this embodiment, the MAC layer 220 can notify (by the DRX transition indication or the Non-DRX transition indication) the PHY layer 210 of the transition to the DRX state (or the return to the non-DRX state). This makes it possible to cause the PHY layer 210 to recognize that the RRM measurement is not to be executed during a session in the DRX state.

### (5) Other Embodiments

The details of the present invention have been described above with reference to the embodiment. However, it is obvious to those skilled in the art that the present invention is not limited to the above descriptions and that various modifications and improvements are possible.

For example, in the above-described embodiment, the transmission of the measurement report is cancelled in the RRC_Connected state and concurrently in the DRX state. Here, transmission of another RRC message (such as a UE information response) may be cancelled instead of the measurement report. That is to say, the UE 200 may cancel the transmission of a message on the RRC layer in the RRC_Connected state and concurrently in the DRX state.

Meanwhile, the block diagram (FIG. 2) used for the explanation of the above-mentioned embodiment represents a functional block diagram. These functional blocks (constituent portions) are realized by any combination of hardware and/or software. In the meantime, means for realizing each of the functional blocks is not limited to particular means. That is to say, each functional block may be realized by a single device which is bound physically and/or logically, or may be realized by two or more physically and/or logically separated devices that are connected directly and/or indirectly (by wire and/or wirelessly, for example).

Furthermore, the above-described UE 200 may function as a computer that executes processing of a radio communication method of the present invention. FIG. 10 is a diagram showing an example of a hardware configuration of the UE 200. As shown in FIG. 10, the UE 200 may be structured as a computer apparatus which includes a processor 1001, a memory 1002, a storage 1003, a communication device 1004, an input unit 1005, an output unit 1006, a bus 1007, and so forth.

Each of the functional blocks of the UE 200 (see FIG. 2) is realized by any of hardware elements of the computer apparatus or by a combination of the hardware elements.

The processor 1001 controls the entire computer by executing an operating system, for example. The processor 1001 may be formed from a central processing unit (CPU) which includes an interface with a peripheral device, a control device, an arithmetic device, a register, and the like.

The memory 1002 is a computer-readable recording medium, which may be formed from at least one of a ROM (read only memory), an EPROM (erasable programmable ROM), an EEPROM (electrically erasable programmable ROM), a RAM (random access memory), and the like, for example. The memory 1002 may also be called a register, a cache, a main memory (a main storage device), and the like. The memory 1002 can save a program (a program code), a software module, and the like which can implement the method according to the above-described embodiment.

The storage 1003 is a computer-readable recording medium, which may be formed from at least one of an optical disc such as a CD-ROM (compact disc ROM), a hard disk drive, a flexible disk, a magneto-optical disk (such as a compact disc, a digital versatile disc, and a Btu-ray (registered trademark) disc), a smart card, a flash memory (a card, a stick, and a key drive, for example), a Floppy (registered trademark) disk, a magnetic strip, and the like. The storage 1003 may also be called an auxiliary storage device. The above-mentioned recording medium may be any of a database, a server, and other appropriate media which include the memory 1002 and/or the storage 1003.

The communication device 1004 is hardware (a transmission-reception device) for performing communication between computers through wired and/or wireless networks, which is also called a network device, a network controller, a network card, a communication module, and the like.

The input unit 1005 is an input device which receives inputs from outside (such as a keyboard, a mouse, a microphone, a switch, a button, and a sensor). The output unit 1006 is an output device which conducts output to the outside (such as a display, a speaker, and an LED lamp). Here, the input unit 1005 and the output unit 1006 may take an integrated form (such as a touch panel).

Meanwhile, the respective units including the processor 1001, the memory 1002, and so forth are connected to one another through the bus 1007 for communicating information. The bus 1007 may be formed of a single bus, or may be formed from different buses that connect different pairs of the devices.

In the meantime, the notification of information is not limited only to the above-described embodiment but may also be carried out in accordance with other methods. For example, the notification of the information may be carried out by any one or a combination of physical layer signaling (such as DCI (downlink control information) and UCI (uplink control information)), upper layer signaling (such as RRC signaling, MAC (medium access control) signaling, broadcast information (MIB (master information block) or SIB (system information block)), and other signals. Meanwhile, the RRC signaling may also be called an RRC message, which may include an RRC connection setup message, an RRC connection reconfiguration message, and the like.

Furthermore, the inputted and outputted information may be saved in a particular location (such as the memory) or managed by using a management table. The inputted and outputted information may be overwritten, updated, or added. The outputted information may be deleted. The inputted information may be transmitted to another device.

The order of elements in the sequence, the flowchart, and the like in the above-described embodiment may be permuted unless such permutation derives a contradiction.

Meanwhile, in the above-described embodiment, the specific operations to be executed by the eNB 100 may be executed by another network node (device) as needed. Alternatively, the functions of the eNB 100 may be provided by a combination of other network nodes.

Note that the terms described in this specification and/or the terms necessary for the understanding of this specification may be replaced by other terms that signify the same or similar meanings. For example, when there is an applicable description, the terms channel and/or symbol may be replaced by the term signal. In the meantime, the term signal may be replaced by the term message. Meanwhile, the terms “system” and “network” may be used interchangeably with each other.

Moreover, parameters and others may be expressed by absolute values, relative values derived from a given value, and different information corresponding thereto. For example, the radio resources may be directed by using indices.

The eNB 100 (the base station) can hold one or more (such as three) cells (which are also called sectors). When the base station holds multiple cells, the entire coverage area by the base station may be divided into multiple smaller subareas. Each of the smaller subareas can also provide communication services by using a base station subsystem (such as an indoor small base station called an RRH (remote radio head)).

The term “cell” or “sector” represents part or all of the coverage area by the base station and/or the base station subsystem to provide the communication services in this coverage. Furthermore, the terms “base station”, “eNB”, “cell”, and “sector” may be used interchangeably with one another in this specification. In some cases, the base station may also be called by a different term such as a fixed station, a NodeB, an eNodeB (eNB), an access point, a femtocell, a small cell, and the like.

The UE 200 may also be called in some other appropriate terms by those skilled in the art. Such appropriate terms include a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, and so forth.

The expression “based on” used in this specification does not mean “based only on” unless otherwise clearly stated. In other words, the expression “based on” means both “based only on” and “based at least on”.

Meanwhile, the terms “including”, “comprising” and variants thereof are intended to be open-ended as with the term “provided with”. In addition, the term “or” used in this specification or in the claims is intended not to be an exclusive-or expression.

Any reference to the elements with designations such as “first”, “second”, and the like does not generally limit the quantities or the order of those elements. These designations may be used in this specification as a convenient method for discriminating two or more elements from one another. Accordingly, reference to certain first and second elements neither means that only the two elements are adoptable therein nor means that the first element is supposed to take priority over the second element in some way.

In the entirety of this specification, if particles including a, an, and the are added as a consequence of translation into English, such a particle does not exclude a possibility of providing two or more of the same elements unless the context clearly specifies that such a plurality is inapplicable.

As described above, the details of the embodiments of the present invention have been disclosed. However, it should not be understood that the description and drawings which constitute part of this disclosure limit the present invention. From this disclosure, various alternative embodiments, examples, and operation techniques will be easily found by those skilled in the art.

Note that the entire content of Japanese Patent Application No. 2017-017970 (filed on Feb. 2, 2017) is incorporated herein by reference in the present specification.

### INDUSTRIAL APPLICABILITY

According to the user device and the radio communication method described above, it is possible to achieve further battery saving even in the state where the connection on the RRC layer is established.

### EXPLANATION OF THE REFERENCE NUMERALS

10 radio communication system
20 radio access network
100 eNB
200 UE
201 measurement report unit
203 reception state control unit
210 PHY layer
220 MAC layer
230 RLC layer
240 PDCP layer
250 RRC layer

1. User device that transmits a message on a radio resource control layer to a radio access network, comprising:
a reception state control unit that sets the user device to a discontinuous reception state in a connected state where connection on the radio resource control layer is established, wherein
the reception state control unit cancels transmission of the message when the user device is set to the discontinuous reception state.

2. The user device according to claim 1, further comprising:
a measurement report unit that transmits a measurement report to the radio access network, the measurement report containing a reception quality of at least one of a serving cell and a neighboring cell, wherein
the measurement report unit cancels the transmission of the measurement report when the user device is set to the discontinuous reception state by the reception state control unit.

3. The user device according to claim 2, wherein on a medium access control layer, the measurement report unit cancels transmission of a corresponding signal corresponding to the measurement report.

4. The user device according to claim 3, wherein the measurement report unit cancels the transmission of the corresponding signal based on an indicator of the measurement report notified from the radio resource control layer.

5. The user device according to claim 2, wherein the measurement report unit cancels the transmission of the measurement report on the radio resource control layer.

6. The user device according to claim 5, wherein the measurement report unit cancels the transmission of the measurement report based on notification of transition of the user device to the discontinuous reception state from a medium access control layer.

7. The user device according to claim 2, wherein the measurement report unit notifies a physical layer of cancellation of the transmission of the measurement report on a medium access control layer.

8. A radio communication method comprising:
transmitting a message on a radio resource control layer to a radio access network;
setting user device to a discontinuous reception state in a connected state where connection on the radio resource control layer is established; and
cancelling transmission of the message when the user device is set to the discontinuous reception state.

9. The radio communication method according to claim 8, further comprising:
transmitting a measurement report to the radio access network, the measurement report containing a reception quality of at least one of a serving cell and a neighboring cell; and
cancelling the transmission of the measurement report when the user device in the connected state is set to the discontinuous reception state.
